(19) United States
(12) Patent Application Publication
(10) Pub. No.: US 2008/0198186 A1
(43) Pub. Date: Aug. 21, 2008

(54) LIQUID EJECTING APPARATUS AND PROGRAM

(75) Inventor: Hitoshi HAYAKAWA, Shiojiri-shi (JP)

Correspondence Address: WORKMAN NYDEGGER, 60 EAST SOUTH TEMPLE, 1000 EAGLE GATE TOWER, SALT LAKE CITY, UT, 84111, US

(73) Assignee: SEIKO EPSON CORPORATION, Tokyo (JP)

(21) Appl. No.: 12/034,287

(22) Filed: Feb. 20, 2008

(30) Foreign Application Priority Data
Feb. 20, 2007 (JP) 2007-038922

(51) Int. Cl. B41J 29/38

(52) U.S. Cl. 347/6

(57) ABSTRACT

A liquid ejecting apparatus that has a display and a cartridge of a predetermined liquid capacity loaded therein and can display information on the cartridge in the display. The liquid ejecting apparatus includes a program for performing a reception sequence for receiving the information on the cartridge from a memory included in the cartridge, an image display sequence for displaying a capacity viewing image having a size corresponding to the liquid capacity and displaying a remaining liquid viewing image that changes in accordance with the amount of remaining liquid inside the cartridge within the displayed capacity viewing image, and a supplementary information display sequence for complementarily displaying supplementary information on the liquid capacity in addition to the image display sequence.

### BACKGROUND

1. Technical Field

The present invention relates to a liquid ejecting apparatus and a program.

2. Related Art

Generally, ink jet printers and printers of other types have a function for noticing a user of the amount of remaining ink in a case where a printing process is performed. In particular, when a printer driver is installed to a computer connected to a printer, a printer window indicating the progress status of a printing process is displayed in a case where the printing process is performed by using the computer. In such a printer window, a remaining ink display image indicating the amount of remaining ink of an ink cartridge is included. In the remaining ink display image, the amount of remaining ink for each cartridge is displayed. In addition, among recently developed printers, there are printers of a type having a display panel such as a liquid crystal. In the printers of the above-described type, the above-described remaining ink display image can be displayed.

In addition, recently, there are cases where ink capacities of cartridges for storing ink are different even in a case where the cartridges have a same size. Thus, as a prior art relating to a printer window that indicates the amount of remaining ink in correspondence with differences of the ink capacities, there is technology disclosed in JP-A-2002-46291 (see an abstract, FIG. 3, and the like thereof). In JP-A-2002-46291, the amount of remaining ink can be precisely acquired by displaying an ink graphic having a size corresponding to total capacity information based on the total capacity information of the ink cartridge.

In the printer window disclosed in JP-A-2002-46291, there is a problem that it is difficult to acquire the ink capacity of a currently used cartridge, for example, in a case where the sizes of the cartridges are the same and there is a small difference between ink capacities. Accordingly, there is a problem that a user may select a cartridge of an incorrect size for replacement of the cartridge. Therefore, it is preferable that the ink capacity of the cartridge is displayed in a state that can be easily noticed.

When a cartridge loaded into the printer is used up for a recommended period and is replaced with a new cartridge, it is economical to a user and can prevent solidification of ink in a nozzle of a print head or the like. Accordingly, it is preferable that a user purchases a cartridge of an optimal ink capacity and loads the cartridge into the printer such that all the ink droplets inside the cartridge are used within a recommended period. However, it is difficult for a user to determine a cartridge of an optimal ink capacity.

### SUMMARY

An advantage of some aspects of the invention is that it provides a printing apparatus and a program capable of indicating ink capacity of a cartridge in an easy manner and guiding a cartridge of an optimal ink capacity.

According to a first aspect of the invention, there is provided a printing apparatus that has a display and a cartridge of a predetermined ink capacity loaded therein and can display information on the cartridge in the display. The printing apparatus includes a program for performing: a reception sequence for receiving the information on the cartridge from a memory included in the cartridge; an image display sequence for displaying a capacity viewing image having a size corresponding to the ink capacity and displaying a remaining ink viewing image that changes in accordance with the amount of remaining ink inside the cartridge within the displayed capacity viewing image; and a supplementary information display sequence for complementarily displaying supplementary information on the ink capacity in addition to the image display sequence.

In the printing apparatus having such a configuration, the capacity viewing image having a size according to the ink capacity is displayed, and thus it is possible to recognize the ink capacity of the currently loaded cartridge in an easy manner. Accordingly, it is possible to prevent a problem that a cartridge of an incorrect size is selected especially from among cartridges having small differences of ink capacities. In addition, since the remaining amount viewing information changing in accordance with the amount of remaining ink of the cartridge is displayed in the capacity viewing image, the amount of the remaining ink can be visually recognized in an easy manner. In addition, since the supplementary information on the ink capacity is additionally displayed in a complementary manner, the user can acquire the ink capacity of the currently using cartridge in an easy manner.

According to a second aspect of the invention, in the above-described printing apparatus, a length of the capacity viewing image in the longitudinal direction is displayed as a size corresponding to the ink capacity in the image display sequence. In the printing apparatus having such a configuration, since the size of the capacity viewing image in the longitudinal direction changes in accordance with the ink capacity, the ink capacity can be visually recognized by the user in an easy manner. In addition, the user can acquire the absolute value of the amount of remaining ink in an easy manner.

According to a third aspect of the invention, in the above-described printing apparatus, a length of the capacity viewing image in the width direction is displayed as a size corresponding to the ink capacity in the image display sequence. In the printing apparatus having such a configuration, since the size of the capacity viewing image in the width direction changes in accordance with the ink capacity, the user can visually recognize the ink capacity in an easy manner. In addition, the user can acquire the absolute value of the amount of remaining ink in an easy manner.

According to a fourth aspect of the invention, in the above-described printing apparatus, as the supplementary information, character information or symbol information representing the predetermined ink capacity is displayed in the supplementary information display sequence. In the printing apparatus having such a configuration, since as the supplementary information, character information or symbol information representing the predetermined ink capacity is displayed, the user can acquire the ink capacity of the currently using cartridge in an easier manner.

According to a fifth aspect of the invention, in the above-described printing apparatus, the program further includes: an optimal size calculating sequence for determining a cartridge candidate of an optimal ink capacity in accordance with a next timing for replacing the cartridge based on a use pattern of ink stored in the cartridge; and an announcement sequence that announces the cartridge candidate of the optimal ink capacity determined by the optimal size calculating sequence.

In the printing apparatus having such a configuration, a cartridge candidate of an optimal ink capacity in accordance with a next timing for replacing the cartridge is determined by the optimal size calculating sequence. Thus, the user can purchase a cartridge of an optimal ink capacity in accordance with a timing for purchase of a next cartridge. Accordingly, when there is a cartridge that has not been used much, a cartridge candidate of a small ink capacity can be announced. When the user purchase a cartridge of a small ink capacity based on the announcement, the user can avoid unnecessary expenses. On the other hand, when there is a cartridge having a high usage frequency, a cartridge candidate of a large ink capacity can be announced, and accordingly, it is possible to reduce inconvenience of replacing the cartridge and suppress expenses for the supplies at maximum extent. In addition, it is possible to consume the entire cartridge within a recommended period by announcing the cartridge of an optimal ink capacity. Accordingly, it is possible to prevent the occurrence of a problem that the ink head is clogged due to solidification of ink and to prevent deterioration of the image quality due to increase in the ink viscosity.

According to a sixth aspect of the invention, in the above-described printing apparatus, the optimal size calculating sequence determines the cartridge candidate of the optimal ink capacity based on the predetermined ink capacity of the cartridge and a load period of the cartridge in a case where the amount of remaining ink is below a specified amount.

In the printing apparatus having such a configuration, since the optimal size calculating module can determine an optimal cartridge candidate in a case where the amount of the remaining ink becomes below the specified amount, the user can purchase a cartridge on the basis of the determine cartridge candidate. Accordingly, the user can avoid unnecessary expenses, and it becomes possible to provide convenience to the user.

According to a seventh aspect of the invention, in the above-described printing apparatus, the optimal size calculating sequence determines the cartridge candidate of the optimal ink capacity based on the amount of ink consumption of the cartridge within a predetermined period and the predetermined period.

In the printing apparatus having such a configuration, the optimal cartridge candidate is acquired all the time in principle from the relationship between the amount of ink consumption in the used cartridge for a predetermined period and the period. Thus, when the user purchase a cartridge on the basis of cartridge candidate acquired all the time in principle, unnecessary expenses can be avoided, and it becomes possible to provide convenience to the user.

According to an eight aspect of the invention, in the above-described printing apparatus, the program reads out ink capacity information of the cartridge, remaining ink information that is information on the amount of remaining ink inside the cartridge, information on a color type of the cartridge, and supplementary information on the ink capacity from the memory, non-use information representing that the cartridge is not used is stored in the memory in a case where the cartridge has not been used, and the program replaces the non-use information with use completion information representing that use of the cartridge is completed in a case where the cartridge has been used at least once.

In the printing apparatus having such a configuration, the program reads out ink capacity information, remaining ink information, information on a color type, supplementary information, and the like, and such information is reflected to be displayed in the image information display sequence and the supplement information display sequence. In addition, since non-use information or use-completion information indicating whether the cartridge has not been used is stored in the memory, it can be determined whether the cartridge is taken away after being loaded once. Here, especially when a not-used cartridge is loaded, it is essential to perform a sucking operation for air between the cartridge and the print head. However, by referring to the non-use information or use-completion information, it is possible to determine whether the sucking operation has been performed.

According to a ninth aspect of the invention, there is provided a program that is loaded into a printing apparatus, in which a cartridge is loaded, and is used for displaying information on the cartridge in a display in a case where the cartridge of a predetermined ink capacity is loaded. The program performs: a reception sequence for receiving the information on the cartridge from a memory included in the cartridge; an image display sequence for displaying a capacity viewing image having a size corresponding to the ink capacity and displaying a remaining ink viewing image that changes in accordance with the amount of remaining ink inside the cartridge within the displayed capacity viewing image; and a supplementary information display sequence for complementarily displaying supplementary information on the ink capacity in addition to the image display sequence.

When the program is configured as described above, in the printing apparatus in which the program is loaded, the capacity viewing image having a size according to the ink capacity is displayed, and thus it is possible to recognize the ink capacity of the currently loaded cartridge in an easy manner. In addition, since the remaining amount viewing information changing in accordance with the amount of remaining ink of the cartridge is displayed in the capacity viewing image, the amount of the remaining ink can be visually recognized in an easy manner. In addition, since the supplementary information on the ink capacity is additionally displayed in a complementary manner, the user can acquire the ink capacity of the currently using cartridge in an easy manner.

### BRIEF DESCRIPTION OF THE DRAWINGS

The invention will be described with reference to the accompanying drawings, wherein like numbers reference like elements.

FIG. 1 is a diagram showing the schematic configuration of a printing apparatus according to an embodiment of the invention.

FIG. 2 is a block diagram showing the configuration of the printing apparatus shown in FIG. 1.

FIG. 3 is a side sectional view showing the schematic configuration of a cartridge according to an embodiment of the invention.

FIG. 4 is a block diagram showing the schematic configuration of a computer according to an embodiment of the invention.

FIG. 5 is a diagram showing an example of a program stored in a computer according to an embodiment of the invention.

FIG. 6 is a diagram showing an example of a printer window displayed in a display according to an embodiment of the invention.

FIG. 7 is a diagram showing another example of a printer window displayed in a display according to an embodiment of the invention.

FIG. 8 is a diagram showing another example of a printer window displayed in a display according to an embodiment of the invention.

FIG. 9 is a diagram showing another example of a printer window displayed in a display according to an embodiment of the invention.

FIG. 10 is a diagram showing an example of a setting window displayed in a display according to an embodiment of the invention.

FIG. 11 is a diagram showing a first process flow for printing in a printing apparatus according to an embodiment of the invention.

FIG. 12 is a diagram showing a second process flow for printing in a printing apparatus according to an embodiment of the invention.

### DESCRIPTION OF EXEMPLARY EMBODIMENTS

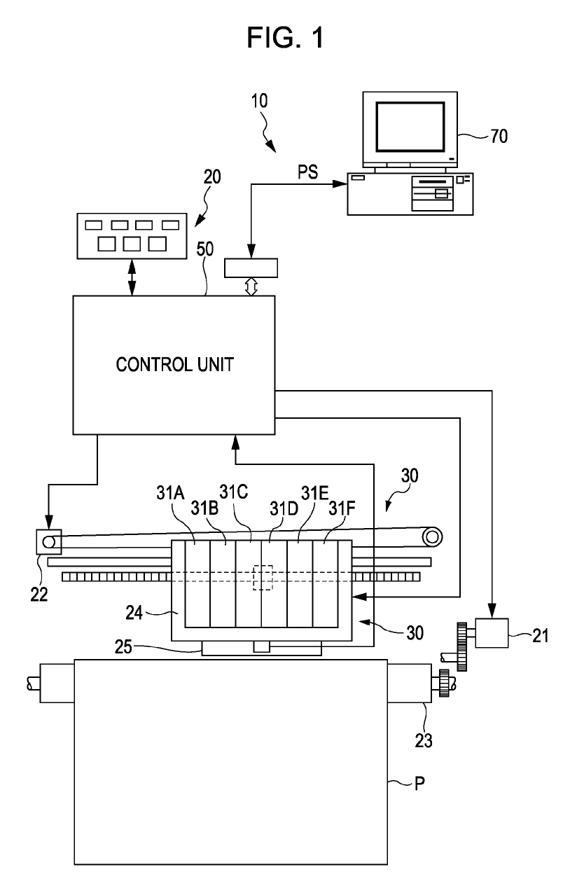

Hereinafter, a printing apparatus 10 according to an embodiment of the present invention will be described with reference to FIGS. 1 to 12. In descriptions below, a combination of a printer 20 and a computer 70 will be referred to as the printing apparatus 10. In the concept of the printing apparatus 10, an apparatus in which the printer 20 and the computer 70 are interconnected through a cable, a network, or the like and an apparatus in which the computer 70 is built-in inside the printer 20 capable of performing a printing process as a so-called stand alone type are included. When functions of the computer 70 to be described later are embedded in the printer 20, the printer 20 corresponds to the printing apparatus 10.

### Schematic Configuration of Printer

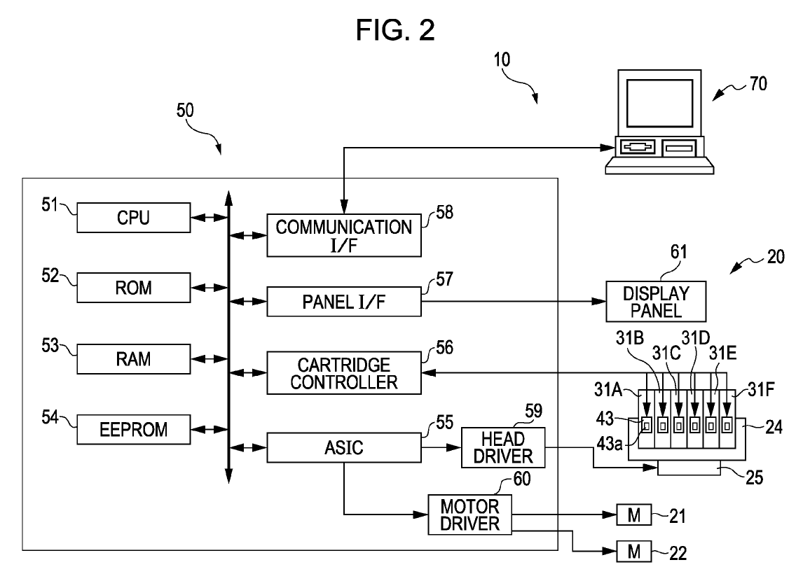

First, the schematic configuration of the printer 20 will be described. FIG. 1 is a diagram showing the schematic configuration of a printing apparatus according to an embodiment of the invention. FIG. 2 is a block diagram showing major parts of the printer 20 of the printing apparatus 10 with a focus on a control unit 50.

As shown in FIG. 1, the printer 20 has a sub scanning transport mechanism that transports a print target (hereinafter, referred to as a print sheet P) by using a paper transport motor 21 and a paper transport roller 23 and a main scanning transport mechanism that reciprocates a carriage 24 in the direction of a shaft of the paper transport roller 23 by using the carriage motor 22. Here, the direction of transporting the print sheet P performed by the sub scanning transport mechanism is referred to as a sub scanning direction, and the direction of transporting the carriage 24 performed by the main scanning transport mechanism will be referred to as a main scanning direction.

In addition, the printer 20 includes a print head unit 30 having a print head 25 loaded in the carriage 24. Here, in the carriage 24, a plurality of electrical nodes (not shown) is disposed. These electrical nodes are brought into contact with terminals included in a circuit substrate 43 of a cartridge 31 to be described later. Through these electrical nodes, information stored in the circuit substrate 43 is read-out or written.

Below the carriage 24, the print head 25 is disposed. In the print head 25, nozzles serving as ink ejecting spots are disposed in an array shape in the transport direction of the print sheet P so as to form nozzle arrays corresponding to ink of each color. In addition, in the nozzle arrays, a piezo element (not shown) that is one of an electrostrictive element and has a superior responsiveness is disposed for each nozzle. By the operation of this piezo element, a corresponding wall surface is pushed, and it becomes possible to eject ink droplets from a nozzle disposed in an end portion of the ink path. Depending on the voltage level applied to the piezo element, ink droplets of different sizes can be ejected. For example, in this embodiment, dots having different sizes of three kinds including large, medium, and small can be formed.

Alternatively, the print head 25 may use a method other than a piezo drive method using a piezo element. As the method, for example, a heater method using a force of bubbles generated by heating ink with a heater, a magnetostriction method using a magnetostrictive element, an electro-static method using an electro-static force, or a mist method controlling mist in an electrical field may be primarily used.

### Configuration of Cartridge

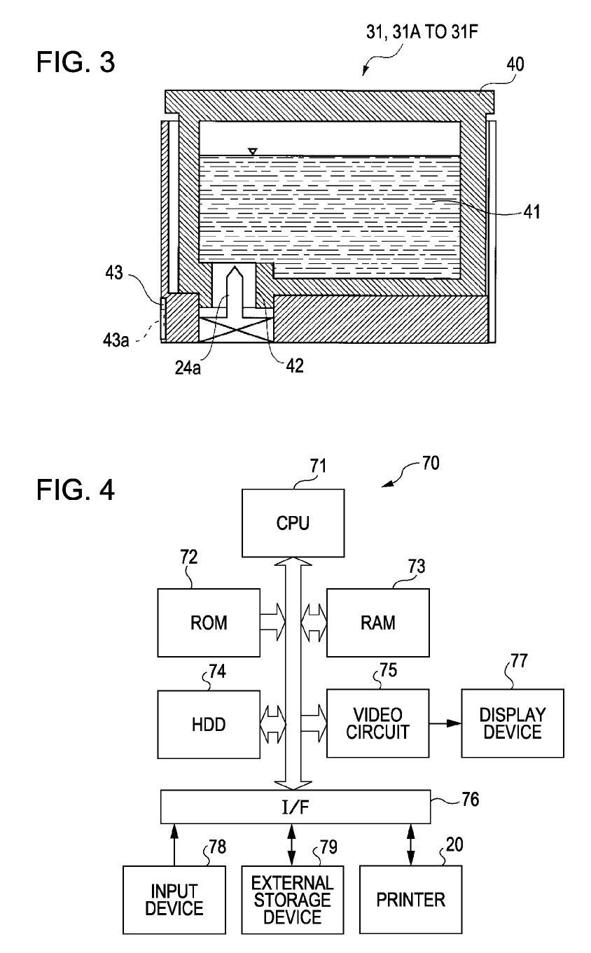

Next, the configuration of the cartridge 31 will be described with reference to FIGS. 2, 3, and the like. To the carriage 24, as shown in FIG. 1, six ink cartridges 31A to 31F including a cartridge 31A storing ink K (black), a cartridge 31B storing ink C (cyan), a cartridge 31C storing ink LC (light cyan), a cartridge 31D storing ink M (magenta), a cartridge 31E storing ink LM (light magenta) and a cartridge 31F storing ink Y (yellow) are detachably attached.

In description below, when the cartridges 31A to 31F are collectively indicated, it is referred to as cartridges 31. The cartridges 31 are not limited to six colors and may be several colors such as four colors, seven colors, or eight colors. In addition, the ink filled in the cartridges 31 is not limited to dye-based ink and may be any other type of ink such as pigment-based ink.

The schematic configuration of the cartridge 31 will now be described with reference to FIG. 3. The cartridge 31 has an ink storage chamber 41 inside a casing 40, and the ink storage chamber 41 is configured to communicate with an ink supply opening 42. In addition, the ink supply opening 42 protrudes downward from the casing 40 in the shape of a cylinder, and to the lower end of the ink supply opening 42, a film that is not shown in the figure is attached. By attaching the film, the ink supply opening 42 and the ink storage chamber 41 are sealed from the outside thereof. However, an ink supply needle 24a is disposed in the carriage 24, the cartridge 31 is installed in a predetermined position of the carriage 24, and the ink supply needle 24a tears the film in a state for holding the cartridge 31 in the carriage 24.

As the type of the cartridge 31, there is a so-called off-carriage type in which the cartridge is loaded in a fixed place other than the carriage 24 of the printer 20 in addition to a so-called on-carriage type in which the cartridge is loaded in the carriage 24 as described above. In the cartridge of the off-carriage type, to a loading spot (holding spot) of the carriage 24, an ink supply tube is connected, and ink can be supplied to the carriage 24 through the ink supply tube.

In addition, in the casing 40, the circuit substrate 43 is installed in a state to be integrated with the casing 40. This circuit substrate 43 has a memory 43a (storage element) such as an IC chip that stores information on ink such that the information can be written. As the information on the ink, for example, there are color type data of ink stored in the cartridge 31, ink type data of dye-based/pigment-based ink, ink capacity data representing the amount of ink initially filled in the cartridge 31, remaining ink data, serial number data, effective date data, and target model data indicating models that can use the cartridge 31.

### Control Unit and the Like of Printer

As shown in FIG. 2, the control unit 50 includes a CPU (Central Processing Unit) 51, a ROM (Read Only Memory) 52, a RAM (Random Access Memory) 53, an EEPROM (Electronically Erasable and Programmable ROM) 54, an ASIC (Application Specific Integrated Circuit) 55, a cartridge controller 56, a panel I/F 57, a communication I/F 58, a head driver 59, a motor driver 60, and the like. These components are interconnected together for transmitting/receiving data therebetween.

Among the above-described components, the CPU 51 performs various calculation processes in accordance with a program stored in the ROM 52 or the EEPROM 54 for controlling each unit of the printer 20. In the ROM 52, a control program for controlling the printer 20, data needed for processes, and the like are stored. The RAM 53 is a memory in which the CPU 51 temporarily stores a program in execution, data in the process of calculation, or the like. In addition, the EEPROM 54 is a memory for storing various types of data required to be maintained even after the printer 20 is turned off. In the ROM 52 or the EEPROM 54, a same program as a printer driver program 90 to be described later is stored.

The ASIC 55 is an IC dedicated for driving the print head 25 and various motors based on signals from various sensors not shown in the figure.

The cartridge controller 56 is a part for controlling an access to the memory 43a included in the cartridge 31 based on a direction from the CPU 51. In particular, the cartridge controller 56 reads out the color type data of ink, the ink type data of dye-based/pigment-based ink, the ink capacity data representing the amount of ink initially filled in the cartridge 31, the remaining ink data, the serial number data, the effective date data, the target model data indicating models that can use the cartridge 31, and the like from the memory 43a. In addition, when the print head 25 is driven so as to eject ink droplets, the cartridge controller 56 updates the remaining amount of ink in accordance with the amount of ejection.

The panel I/F 57 inputs/outputs signals to/from the display panel 61. Accordingly, in the display panel 61, predetermined information can be displayed. Here, the display panel 61 is a liquid crystal panel disposed in an upper front side of the printer 20 and can display information on the cartridge 31. When a printing process is performed by using a stand-alone mode, this display panel 61 corresponds to the display device 77.

The communication I/F 58 is connected to the computer 70 through a connector not shown in the figure and performs a communication process. Thus, when the printer 20 receives a print signal PS from the computer 70 side, a printing process using the printer 20 is started based on the print signal PS. In addition, the computer 70 receives information on ink of each cartridge 31 from the printer side 20 through the communication I/F 58. Accordingly, in the computer 70 side, a printer window 100 to be described later can be displayed on a screen.

The head driver 59 generates a predetermined voltage in accordance with a direction from the ASIC 55 and applies the voltage to a piezo element inside the print head 25. The motor driver 60 generates a predetermined voltage in accordance with a direction from the ASIC 55 and applies the voltage to various motors.

### Schematic Configuration of Computer

Next, the configuration of a computer 70 of the printing apparatus 10 will be described with reference to FIG. 4. As shown FIG. 4, the computer 70 is configured to include a CPU 71, a ROM 72, a RAM 73, an HDD (Hard Disk Drive) 74, a video circuit 75, and I/F 76, a display device 77, an input device 78, an external storage device 79, and the like. Since the CPU 71, the ROM 72, the RAM 73, and the I/F 76 are the same as the CPU 51, the ROM 52, the RAM 53, and the like of the control unit 50 described above, descriptions thereof are omitted here.

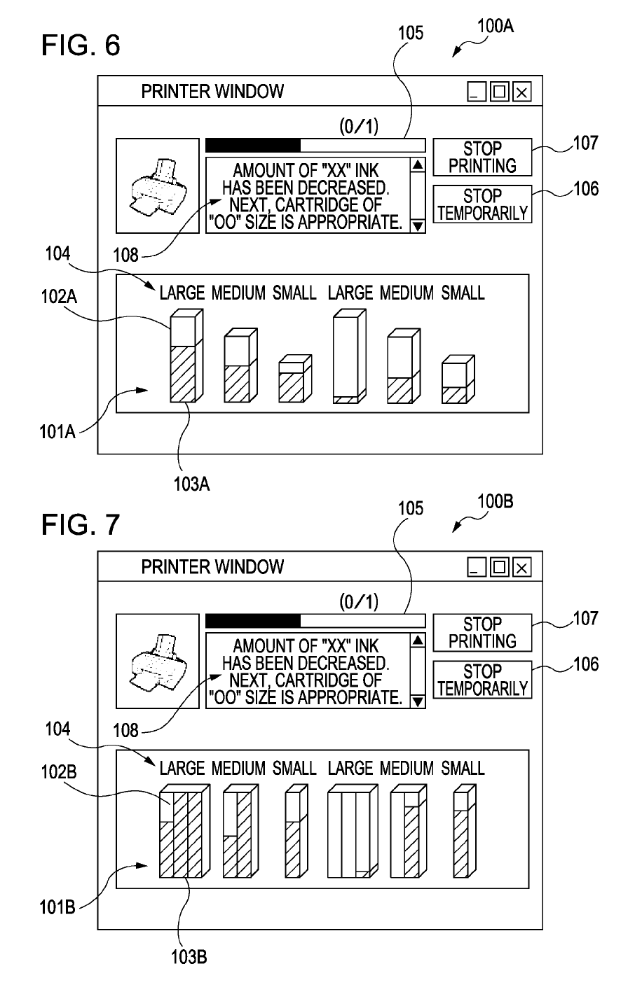

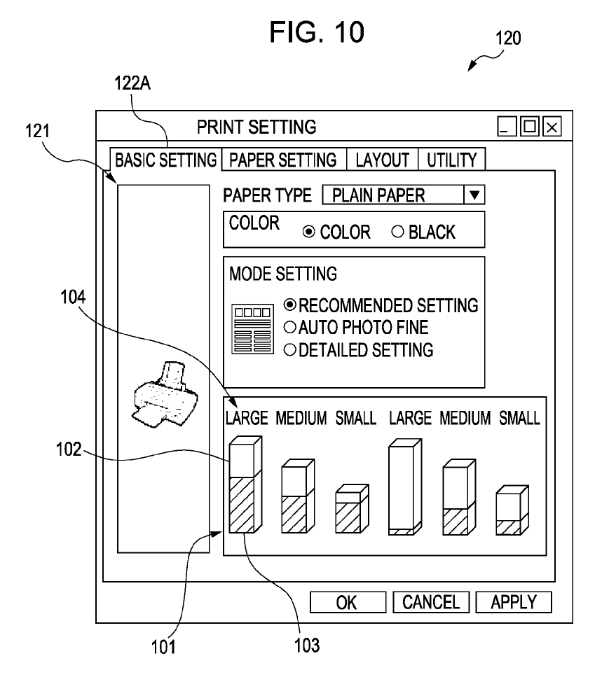

The HDD 74 is a recording device that reads out data or a program stored in a hard disk that is a recording medium in accordance with a request from the CPU 71 and stores data generated by the calculation process of the CPU 71 in the hard disk. Among programs recorded in the HDD 74, the printer driver program 90 is included. In the printer driver program, a display module 96 for displaying a printer window 100 as shown in FIG. 6 and the like and a print setting window 120 as shown in FIG. 10 are included.

The video circuit 75 converts image data acquired by performing a drawing process in accordance with a drawing command supplied from the CPU 71 into a video signal and outputs the video signal to the display device 77. The display device 77, for example, is configured by an LCD (Liquid Crystal Display) monitor or a CRT (Cathode Ray Tube) monitor and displays an image on the basis of the video signal output from the video circuit 75.

The input device 78, for example, represents a keyboard or a mouse and generates a signal on the basis of a user's operation and supplies the signal to the I/F 76. The external storage device 79, for example, is configured by a CD-ROM (Compact Disk-ROM) drive unit, an MO (Magneto Optic) drive unit, or an FDD (Flexible Disk Drive) unit, and reads out data or a program recorded in a CD-ROM disc, an MO disc, or an FD and supplies the data or the program to the CPU 71. The MO drive unit and the FDD unit are devices that record data supplied from the CPU 71 in the MO disc or the FD.

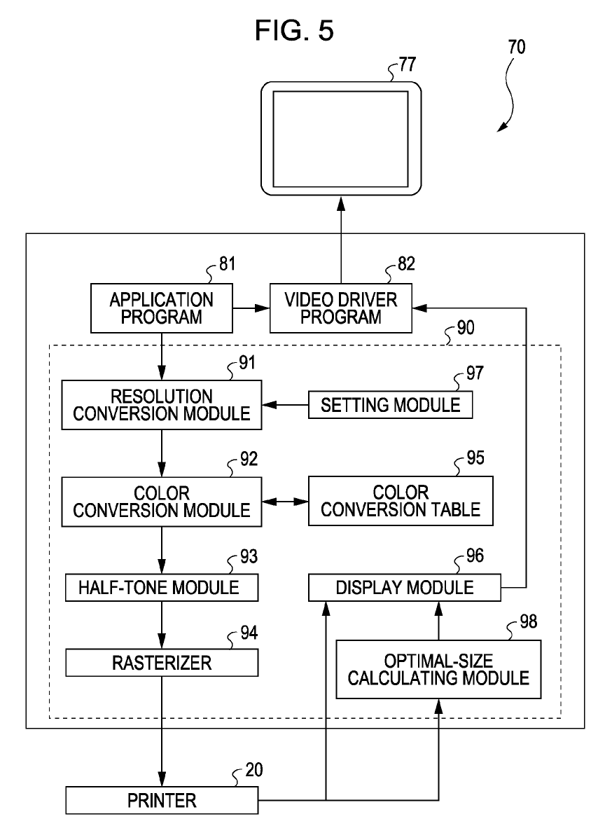

Subsequently, various programs built in the computer 70 will be described with reference to FIG. 5. In the computer 70, an application program 81, a video driver program 82 for driving the video circuit 75, and a printer driver program 90 are built, and thus the printer driver program 90 operates under a predetermined operating system (OS).

Here, the application program 81, for example, is a program for an image process or image display and is executed after an image received from a digital camera or the like is processed, an image drawn by a user is processed, or a predetermined image is displayed, for outputting the image to the printer driver program 90 and the video driver program 82.

The video driver program 82 is a program for driving the video circuit 75, and is executed for generating a video signal and supplying the video signal to the display device 77, for example, after a gamma correction process, white balance adjustment, or the like is performed for image data supplied from the application program 81.

The printer driver program 90 corresponds to a program according to an embodiment of the invention and has a resolution conversion module 91, a color conversion module 92, a half-tone module 93, a rasterizer 94, a color conversion table 95, a display module 96, a setting module 97, an optimal size calculating module 98, and the like as constituent elements. When a print direction is issued from the application program 81 for the image data generated by the application program 81, the printer driver program 90 receives the image data from the application program 81. Then, the printer driver program 90 performs a predetermined process for the received image data and then supplies a print signal PS to the printer 20.

The resolution conversion module 91 converts the resolution of the image data generated by the application program 81 into a resolution for a printing process of the printer 20. The color conversion module 92 performs a conversion process that converts image data of RGB color system into print data (print signal PS) of CMYK (Cyan, Magenta, Yellow, Black) color system for each pixel while referring to a color conversion table 95. Then, the half-tone module 93 performs a half-tone process for the print data represented in the CMYK color system by the process of the color conversion module 92. In the process, a process of decreasing the number of gray scales for representing colors is performed. In particular, for example, a process of decreasing the number of colors into four gray scales of “no-dot forming”, “small-dot forming”, “middle-dot forming”, and “large-dot forming” is performed. Then, the rasterizer 94 performs a process of rearranging the image data for which the half-tone process has been performed in the order of transmission to the printer 20.

The display module 96 has functions for displaying a window (printer window 100A) displayed in accordance with a printing process and displaying a window (print setting window 120) for displaying information on a printing process and setting of the printing process. This display module 96 receives information transmitted from the printer 20 and displays the received information in the display device 77 through the video driver program 82. As the information transmitted from the printer 20 side, there is information on the ink stored in the memory 43a, notification of a print error, and the like.

Here, the display module 96 has a function for displaying a printer window 100A as shown in FIGS. 6 to 9. Among the figures, in the printer window 100A shown in FIG. 6, information on each cartridge 31 is displayed. This display of the information on the cartridge 31 has at least the following elements of (A) and (B).

### (A) Remaining Ink Display Image on the Basis of Ink Capacity

In this embodiment, a remaining ink display image 101 as shown in FIG. 6 is displayed. This remaining ink display image 101 is configured by a capacity viewing image 102A and a remaining amount viewing image 103. Among the images, the capacity viewing image 102A represents an external appearance of the remaining ink display image 101A and is displayed in a size corresponding to the capacity of ink. In other words, for a cartridge 31 having a large ink capacity, a large capacity viewing image 102A is displayed, and for a cartridge 31 having a small ink capacity, a small capacity viewing image 102A is displayed. In FIG. 6, when the ink capacity is large, the height of the remaining ink display image 101A is configured to be displayed large. In addition, the remaining amount viewing image 103 is displayed by using a same technique as is generally used. As the generally used technique, there is a method in which the background of the capacity viewing image 102A is displayed in white, the remaining amount viewing image 103 having a height corresponding to the amount of the remaining amount of the ink is displayed in a color corresponding to the color type of the cartridge 31, and the remaining amount viewing image 103 is represented by a height of a colored portion from the lower side toward the upper side.

The method of displaying the remaining ink display image 101A is not limited to changing the height of the remaining ink display image 101A. For example, as a printer window 100B shown in FIG. 7, a method of changing the width of the remaining ink display image 101B in correspondence with the capacity of ink may be used. In the example shown in FIG. 7, a plurality of the capacity viewing images 102B having a specific width corresponding to the capacity of the ink is arranged in parallel. The width of the remaining ink display image 101B is displayed to change in a stepped manner. The remaining amount viewing image 103B is displayed as a sequentially colored portion corresponding to the color type of the cartridge 31 from the capacity viewing image 102B disposed on the rightmost side.

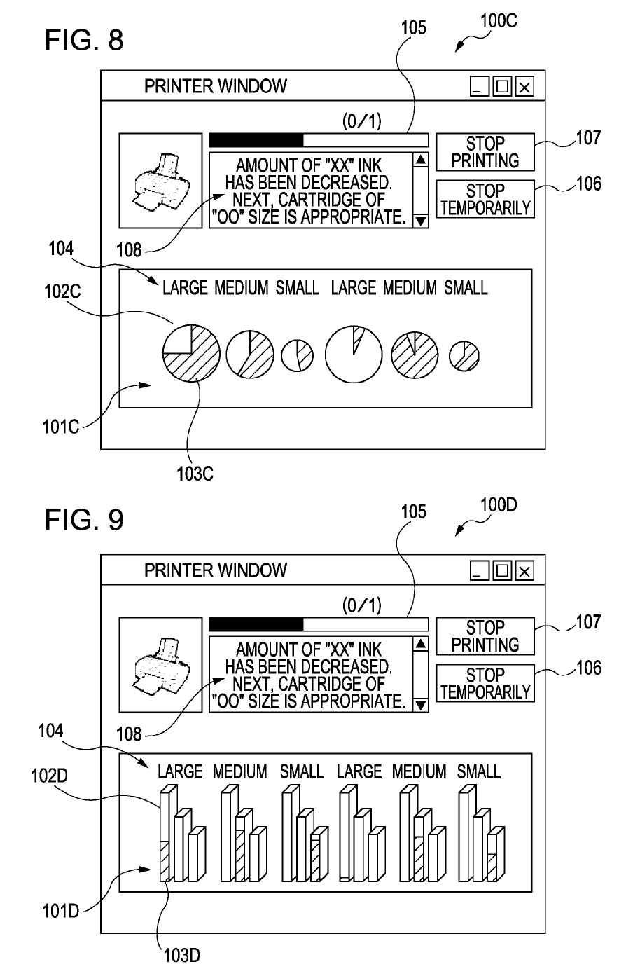

In addition, in a printer window 100C of a display form shown in FIG. 8, the remaining ink display image 101C is displayed in a circular shape. In this remaining ink display image 101C, the capacity viewing image 102C is displayed in a circular shape having a size corresponding to the capacity of ink, and the remaining amount viewing image 103C is represented as sequential colored portions corresponding to the color types of each cartridge 31 in a clockwise direction. In addition, in a printer window 100D of a display form shown in FIG. 9, the remaining ink display image 101D has a plurality (three in FIG. 9) of capacity viewing images 102D and a remaining amount viewing image 103D represented as a colored portion, which corresponds to the color type, in the capacity viewing image 102D corresponding to the type of the ink capacity actually in use.

### (B) Information on Ink Capacity

In addition to the remaining ink display image 101A, information (corresponding to supplement information) on the ink capacity of the cartridge 31 is displayed (hereinafter, this display is referred to as capacity information display 104). As the capacity information display 104, for example, there are character display such as “L” for a cartridge 31 having a large ink capacity, character display such as “S” for a cartridge 31 having a small ink capacity, and character display such as “M” for a cartridge 31 having a medium ink capacity that is an ink capacity between the large capacity and the small capacity. However, the capacity information display 104 is not limited to character display and may be represented in various display forms such as an image changing in size in accordance with the ink capacity, a circular gauge, identification information on the type of ink capacity, and the number of images.

In addition, in the printer windows 100A and 100D shown in FIGS. 6 to 9, progress meter display 105 representing a progress status of a printing process, print stop button display 106 for stopping a printing process, and pause button display 107 for temporarily stopping a printing process are additionally displayed.

In addition, the display module 96 has a function for displaying announcement display 108, as shown in FIG. 6 and the like, in the printer window 100 in a case where the calculation result of the optimal size calculating module 98 is received. In this announcement display 108, a message (announcement) indicating “Next, a cartridge of an “AA” size is appropriate.” with a message urging to replace the cartridge 31 is displayed. This announcement indicates a recommended cartridge 31 (cartridge candidate) in accordance with a replacement time. As the announcement to be displayed, any announcement for guiding (recommending) a cartridge candidate determined on the basis of the calculation of the optimal size calculating module 98 may be used.

In addition, the display module 96 also has a function for displaying a print setting window 120 as shown in FIG. 10 in addition to the printer window 100. When the print setting window 120 is displayed in accordance with a calculation process in the CPU 51 on the basis of the display module 96, various setting tabs 122 are displayed in this print setting window 120. Among the setting tabs, when a basic setting tab 122A is selected, a basic setting window 121 as shown in FIG. 10 is displayed. Also in this basic setting window 121, a remaining ink display image 101 configured by a capacity viewing image 102 and a remaining amount viewing image 103 and capacity information display 104 are displayed in the same manner as in the printer window 100 shown in FIG. 6 and the like. In addition, in this print setting window 120, the announcement display 108 may be configured to be displayed.

The setting module 97 has functions for setting a printing mode (a pretty mode, a fast mode, or the like) setting a paper size, and the like. Here, a setting process is performed by clicking on button display in the print setting window 120 displayed by the display module 96, selecting a gauge, or the like, and the settings made are reflected on a printing process thereafter through the setting module 97.

The optimal size calculating module 98 determines a cartridge 31 (cartridge candidate) having an optimal ink capacity for the announcement in accordance with a timing for purchasing a next cartridge 31, based on information on the ink capacity of a specific cartridge 31, a use period of the cartridge 31, and the like. The calculation process performed by this optimal size calculating module 98 will be described later.

### First Process Flow for Printing

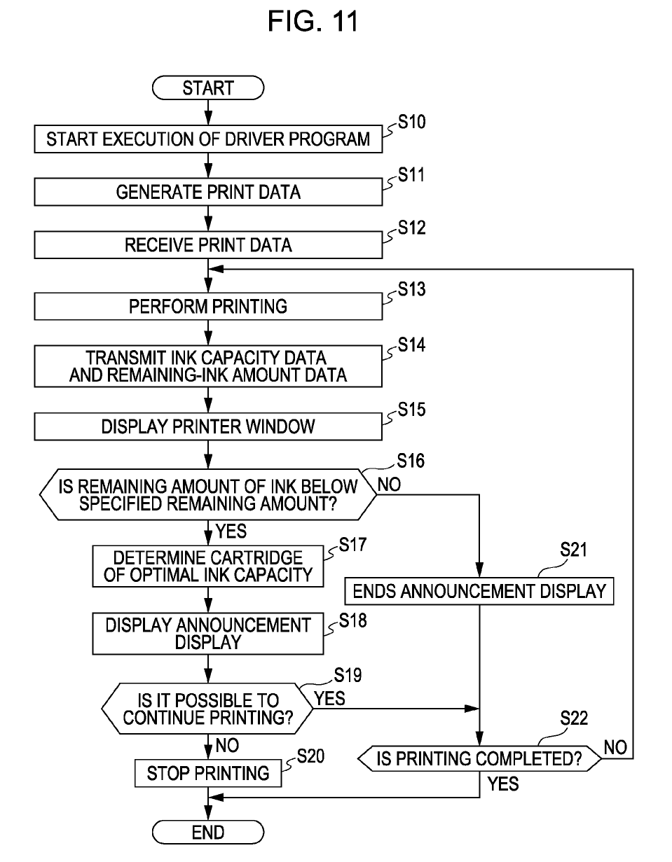

A first process flow for printing using the above-described printing apparatus 10 will be described with reference to FIG. 11.

Before printing, when a user starts execution of the application program 81, displays desired printing target data, and directs a printing process, the printer driver program 90 is started based on the print direction (S10). When the printer driver program 90 is started, a process of generating print data for the print target data is performed (S11). In particular, the print data is generated through a resolution conversion process for print comparison data in accordance with a printing process of the printer 20 using the resolution conversion module 91, a color conversion process by using a color conversion module 92, a half-tone process by using a half-tone module 93, and an arrangement changing process of the transmission sequence by using a rasterizer 94.

After the print data is generated, the print data is transmitted from the computer 70 side to the printer 20 side, and the printer 20 receives the print data (S12). Then, the printer 20 performs a printing process on the basis of the print data (S13).

When the printer 20 is turned on, the cartridge controller 56 reads out the above-described various data from the memory 43a based on the direction from the CPU 51 (corresponding to a reception sequence). Then, the ink capacity data and the remaining ink data included in the read-out data are transmitted from the printer 20 toward the computer 70 as a part of a status signal (S14). In the status signal, additional information, for example, representing a print progress status, paper jam, out-of-paper, and the like is included.

When the computer 70 receives the status signal, the display module 96 is started based on the direction from the CPU 51, and a printer window 100 as shown in FIGS. 6 to 9 is displayed. In the printer window 100, as described above, the remaining ink display image 101 and the capacity information display 104 are displayed (S15; corresponding to an image display sequence and a supplement information display sequence). In addition, in the computer 70, it is determined whether the amount of remaining ink of each cartridge 31 is below a specified remaining amount (S16). Here, when it is determined that the amount of the remaining ink of a cartridge 31 is below the specified remaining amount (in case of “Yes”), the cartridge 31 is determined to be in an ink-low state. On the other hand, when it is determined that the amount of the remaining ink of a cartridge 31 is not below the specified remaining amount (in case of “No”), the cartridge 31 is determined not to be in an ink-low state, and the process proceeds to S21 to be described later. In addition, when the cartridge is replaced with a new cartridge 31, it is determined that the cartridge is not in an ink-low state in S16.

The determination on whether the amount of the remaining ink is below the specified remaining amount may be performed by counting (counted by a dot counter implemented in an ASIC 55) the operations for ejecting ink droplets according to driving of the print head 25. In addition, for example, it may be determined whether the amount of the remaining ink is below the specified remaining amount based on a sensor by additionally disposing the sensor for detecting the amount of the remaining ink.

When a cartridge is determined to be in the ink-low state, a cartridge 31 (cartridge candidate) of an optimal ink capacity is determined by starting the optimal size calculating module 98 based on the ink capacity of the cartridge 31 and the use period of the cartridge 31 (S17; this corresponds to an optimal size calculating sequence). As an example of calculation for this determination process, the calculation process may be performed by calculating “amount of ink capacity of a specific cartridge 31/use period of the specific cartridge 31”. When the result of the calculation is equal to or smaller than 1 g/one month (here, one month is set as 30 days, and hereinafter one month is represented by 1 M. In other words, the above case is represented by “1 g/M”), the amount of ink consumption is small, and accordingly, a determined cartridge candidate is a cartridge 31 having a small capacity. On the other hand, when the result of the calculation in the range of 1 g/M to 4 g/M, the amount of the ink consumption is about medium, and accordingly, a determined cartridge candidate is a cartridge 31 having a medium capacity. On the other hand, when the result of the calculation is equal to or larger than 4 g/M, the amount of the ink consumption is large, and accordingly, a determined cartridge candidate is a cartridge 31 having a large capacity.

After the optimal size calculating module 98 performs the calculation process, the display module 96 receives the calculation result. Then, the display module 96 displays the announcement display 108 as shown in FIG. 6 (S18; this corresponds to an announcement sequence). Thereby, the user can purchase a cartridge 31 of an optimal ink capacity in accordance with a purchase time by visually noticing a message indicating “Next, a cartridge having an “AA” size is appropriate”.

After the announcement display 108 is displayed by the process of S18, it is determined whether the printing process can be continued in the ink-low state (S19). When it is determined that the printing process can be continued (determined to be Yes), the process proceeds to S22 that will be described later. On the other, when it is determined that the printing process cannot be continued (determined to be No) in the determination in S19, an error notification is displayed in the printer window 100, and the printing process is stopped until the cartridge 31 is replaced (S20).

On the other hand, when it is determined that the amount of the remaining ink is not below the specified remaining amount in the above-described determination in S16 (in case of “No”), any cartridge 31 is not in the ink-low state, and accordingly, the display of the announcement display 108 ends (S21). In addition, when it is determined that the printing process can be continued after completion of S21 or in S19, subsequently, it is determined whether the printing process is completed (whether there is a next print job) (S22). When the printing process is determined not to be completed in this determination (in case of “No”), the process proceeds back to the above-described S13, and the printing process is continued.

### Second Process Flow for Printing

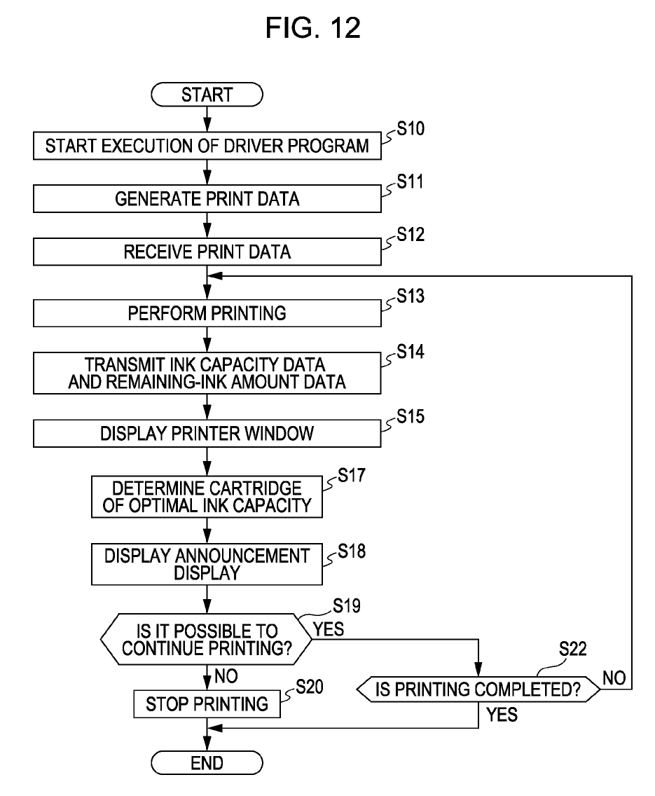

Subsequently, a second process flow for printing using the above-described printing apparatus 10 will be described with reference to FIG. 12. The second process flow is basically the same as the first process flow shown in FIG. 11, and thus a description of duplicate parts is omitted here.

This second flow process is markedly different from the above-described first process flow in that the calculation process of the optimal size calculating module 98 and the display of the optimal announcement display 108 are performed based on the amount of the ink consumption and the use period, basically all the time regardless whether any cartridge is in the low-ink state. Thus, in the process flow shown in FIG. 12, Step S16 shown in FIG. 11 for determining whether the amount of the remaining ink is below the specified remaining amount is not included and thereby the process is simplified. In addition, Step S21 for ending the display of the announcement display 108 is not included.

Here, meaning for using the second process flow instead of the first process flow is as follows. When a user takes a cartridge 31 away regardless that the ink of the cartridge 31 remains sufficiently and is in a usable state, the cartridge has not reached the low-ink state. However, in such a case, when the announcement display 108 is displayed all the time in principle, it is possible to announce an optimal cartridge candidate to the user. In addition, when a calculation process is performed by the optimal size calculating module 98 all the time, the announcement display 108 may not be necessarily displayed continuously.

As an example of the calculation process performed by the optimal size calculating module 98 in the second process flow, the calculation process may be performed by calculating “amount of ink consumption of a specific cartridge 31/use period of the specific cartridge 31”. When the result of the calculation is equal to or smaller than “1 g/1 M”, the amount of the ink consumption is small, and accordingly, a determined cartridge candidate is a cartridge 31 having a small capacity. On the other hand, when the result of the calculation is in the range of 1 g/M to 4 g/M, the amount of the ink consumption is about medium, and accordingly, a determined cartridge candidate is a cartridge 31 having a medium capacity. On the other hand, when the result of the calculation is equal to or larger than 4 g/M, the amount of the ink consumption is large, and accordingly, a determined cartridge candidate is a cartridge 31 having a large capacity.

### ADVANTAGES OF EMBODIMENTS OF PRESENT INVENTION

According to the above-described printing apparatus 10, the capacity viewing image 102 having a size according to the ink capacity is displayed, and thus it is possible to recognize the ink capacity of the currently loaded cartridge 31 in an easy manner. Accordingly, it is possible to prevent a problem that a cartridge of an incorrect size is selected especially from among cartridges having small differences of ink capacities. In addition, since the remaining amount viewing information 103 changing in accordance with the amount of remaining ink of the cartridge 31 is displayed in the capacity viewing image 102, the amount of the remaining ink can be visually recognized in an easy manner. In addition, since the capacity information display 104 is additionally displayed in a complementary manner, the user can acquire the ink capacity of the currently using cartridge 31 in an easy manner.

In addition, according to the display form shown in FIG. 6, since the size of the capacity viewing image 102A in the longitudinal direction changes in accordance with the ink capacity, the ink capacity can be visually recognized by the user in a friendly and easy manner. In addition, the user can acquire the absolute value of the amount of remaining ink in an easy manner. In addition, according to the display form shown in FIG. 7, since the size of the capacity viewing image 102B in the width direction changes in accordance with the ink capacity, the user can visually recognize the ink capacity in an easy manner. In addition, the user can acquire the absolute value of the amount of remaining ink in an easy manner. In addition, according to the display form shown in FIG. 8 or the display form shown in FIG. 9, the user can visually recognize the ink capacity in an easy manner.

In addition, in the embodiment, characters are displayed as the capacity information display 104, and accordingly, the user can acquire the ink capacity of the currently used cartridge 31 in an easier manner.

In addition, in the embodiment, the printer driver program 90 is configured to have an optimal size calculating module 98 and a display module 96 that displays a cartridge 31 on the basis of the calculation process of the optimal size calculating module 98. Thus, the user can purchase a cartridge 31 of an optimal ink capacity in accordance with a timing for purchase of a next cartridge 31. Accordingly, when there is a cartridge 31 that has not been used much, a cartridge candidate of a small ink capacity can be announced. When the user purchase a cartridge 31 of a small ink capacity based on the announcement, the user can avoid unnecessary expenses. On the other hand, when there is a cartridge 31 having a high usage frequency, a cartridge candidate of a large ink capacity can be announced, and accordingly, it is possible to reduce inconvenience of replacing the cartridge and suppress expenses for the supplies at maximum extent.

In addition, it is possible to consume the entire cartridge 31 within a recommended period by announcing the cartridge 31 of an optimal ink capacity. Accordingly, it is possible to prevent the occurrence of a problem that the ink head 25 is clogged due to solidification of ink and to prevent deterioration of the image quality due to increase in the ink viscosity inside the cartridge 31.

In the embodiment, as shown in FIG. 11, the optimal size calculating module 98 can perform a calculation process for determining an optimal cartridge candidate on the basis of the ink capacity of the cartridge 31 and the load period of the cartridge 31 in a case where the amount of the remaining ink becomes below the specified amount. In such a case, the user can purchase a cartridge 31 based on the announcement display 108 at a timing for replacing the cartridge 31. Accordingly, the user can avoid unnecessary expenses by following the announcement, and it becomes possible to provide convenience to the user.

In addition, in the embodiment, the optimal size calculating module 98 can determine an optimal cartridge candidate on the basis of the amount of ink consumption of the cartridge 31 for a predetermined period and the predetermined period. In such a case, the optimal cartridge candidate is acquired all the time in principle from the relationship between the amount of ink consumption in the used cartridge 31 for a predetermined period and the period. Thus, when the user purchase the cartridge 31 in accordance with the announcement display 108 on the basis of the calculation process, unnecessary expenses can be avoided, and it becomes possible to provide convenience to the user.

### MODIFIED EXAMPLES OF PRESENT INVENTION

Although embodiments of the invention have been described, the present invention may be changed in other various forms. Hereinafter, modified examples will be described.

In the above-described embodiment, the optimal size calculating module 98 performs a calculation process for acquiring a cartridge 31 of an optimal ink capacity based on the use pattern of the currently used cartridge 31 such as the use period and the amount of consumption. However, the optimal size calculating module 98 may be configured to perform the calculation process for acquiring the cartridge 31 of an optimal capacity based on the use patterns of cartridges 31 from a cartridge used at a time when the printer 20 is used for the first time to the current cartridge 31.

In addition, according to the above-described embodiment, in the memory 43a, ink capacity data including “L”, “M”, and “S” is stored. However, in the memory 43a, for the cartridge 31 having the ink capacity of “M” or “S”, remaining ink data such as ⅔ or ⅓ of the ink capacity of the cartridge 31 of “L”, for example, with reference to the ink capacity data of “L” may be configured to be stored.

In such a case, in the memory 43a, it is preferable that non-use information indicating whether the cartridge 31 has not been used is stored. In that case, when the cartridge 31 is loaded at least at once, the non-use information is replaced with use-completion information. Accordingly, it can be determined whether a cartridge 31 is taken away after being loaded once. Here, especially when a not-used cartridge 31 is loaded, air is inserted in a portion between the attachment portion of the film and the ink storage chamber 41, and thus it is essential to perform a sucking operation for the air. However, as described above, when the information for determining whether the cartridge 31 is not used or is completed in using is referred to, it is possible to determine whether the sucking operation has been performed. Therefore, it is possible to skip an unnecessary sucking operation.

In addition, in the above-described embodiment, as an example of the calculation process performed by the optimal size calculating module 98, a case where the optimal cartridge 31 is acquired by calculating “ink capacity/use period” or “amount of ink consumption/use period” has been described. However, the calculation process performed by the optimal size calculating module 98 is not limited thereto. For example, the optimal cartridge 31 may be acquired based on the increase rate of the amount of ink consumption. In addition, various factors such as a seasonal factor (a season for sending New Year's cards or the like), a tendency of the print mode (for example, there is a tendency for printing with high precision quality or a tendency for printing with high speed), or a tendency of the printing target (for example, there are many photo prints or there are many prints of a specific pamphlet) may be added for the calculation process.

In addition, in the above-described embodiment, an ink jet printer has been described as the printer 20. However, the type of the printer 20 is not limited thereto. Examples of liquid ejecting apparatuses to which the invention may be applied include: an apparatus having a coloring material ejecting head used for manufacturing a color filer such as a liquid-crystal display or the like; an apparatus having an electrode material (conductive paste) ejecting head used for forming electrodes, such as an organic EL display or a field emission display (FED) or the like; an apparatus having a bio-organic substance ejecting head used for manufacturing a bio-chip; an apparatus having a sample ejecting head serving as a precision pipette; and the like.

The entire disclosure of Japanese Patent Application No. 2007-038922, filed Feb. 20, 2007 is expressly incorporated by reference herein.

What is claimed is:

1. A liquid ejecting apparatus that has a display and a cartridge of a predetermined liquid capacity loaded therein and can display information on the cartridge in the display, the liquid ejecting apparatus comprising a program for performing:
a reception sequence for receiving the information on the cartridge from a memory included in the cartridge;
an image display sequence for displaying a capacity viewing image having a size corresponding to the liquid capacity and displaying a remaining liquid viewing image that changes in accordance with the amount of remaining liquid inside the cartridge within the displayed capacity viewing image; and
a supplementary information display sequence for complementarily displaying supplementary information on the liquid capacity in addition to the image display sequence.

2. The liquid ejecting apparatus according to claim 1, wherein, in the image display sequence, a length of the capacity viewing image in the longitudinal direction is displayed as a size corresponding to the liquid capacity.

3. The liquid ejecting apparatus according to claim 1, wherein, in the image display sequence, a length of the capacity viewing image in the width direction is displayed as a size corresponding to the liquid capacity.

4. The liquid ejecting apparatus according to claim 1, wherein, in the supplementary information display sequence, as the supplementary information, character information or symbol information representing the predetermined liquid capacity is displayed.

5. The liquid ejecting apparatus according to claim 1, wherein the program further comprises:
an optimal size calculating sequence for determining a cartridge candidate of an optimal liquid capacity in accordance with a next timing for replacing the cartridge based on a use pattern of the cartridge; and
an announcement sequence that announces the cartridge candidate of the optimal liquid capacity determined by the optimal size calculating sequence.

6. The liquid ejecting apparatus according to claim 5, wherein the optimal size calculating sequence determines the cartridge candidate of the optimal liquid capacity based on the predetermined liquid capacity of the cartridge and a load period of the cartridge in a case where the amount of remaining liquid is below a specified amount.

7. The liquid ejecting apparatus according to claim 5, wherein the optimal size calculating sequence determines the cartridge candidate of the optimal liquid capacity based on the amount of liquid consumption of the cartridge within a predetermined period and the predetermined period.

8. The liquid ejecting apparatus according to claim 1,
wherein the program reads out liquid capacity information of the cartridge, remaining liquid information that is information on the amount of remaining liquid inside the cartridge, information on a color type of the cartridge, and supplementary information on the liquid capacity from the memory,
wherein non-use information representing that the cartridge is not used is stored in the memory in a case where the cartridge has not been used; and
wherein the program replaces the non-use information with use completion information representing that use of the cartridge is completed in a case where the cartridge has been used at least once.

9. A program that is loaded into a liquid ejecting apparatus, in which a cartridge is loaded, and is used for displaying information on the cartridge in a display in a case where the cartridge of a predetermined liquid capacity is loaded, the program performs:
a reception sequence for receiving the information on the cartridge from a memory included in the cartridge;
an image display sequence for displaying a capacity viewing image having a size corresponding to the liquid capacity and displaying a remaining amount viewing image that changes in accordance with the amount of remaining liquid inside the cartridge within the displayed capacity viewing image; and
a supplementary information display sequence for complementarily displaying supplementary information on the liquid capacity in addition to the image display sequence.
